(19) United States
(12) Patent Application Publication
(10) Pub. No.: US 2017/0331898 A1
(43) Pub. Date: Nov. 16, 2017

(54) DATA MEDIATION SYSTEM AND METHOD

(71) Applicants: Kwang Bum LEE, Gyeonggi-do (KR); Hoon-Kyu LIM, Seoul (KR)

(72) Inventors: Kwang Bum LEE, Gyeonggi-do (KR); Hoon-Kyu LIM, Seoul (KR)

(21) Appl. No.: 15/535,239

(22) PCT Filed: Feb. 4, 2016
(86) PCT No.: PCT/IB2016/050557

§ 371 Date: Jun. 12, 2017

(30) Foreign Application Priority Data
Dec. 12, 2014 (KR) 10-2014-0179490

(51) Int. Cl. H04L 29/08; G06Q 30/02

(52) U.S. Cl. CPC H04L 67/12; G06Q 30/0283; H04L 67/1097

(57) ABSTRACT

The present invention relates to a data mediation system and method. The data mediation system according to the present invention comprises: a plurality of things or devices; a consumer terminal registering data processing rules for generating customized data; and a data mediation server for generating the customized data by applying the data processing rules to data collected from the plurality of things or devices. According to the present invention, various pieces of data and information, which are generated during a service process through the things or devices and a web service mashup, are processed as various types of data and information so as to be mediated between a supplier and a customer.

### TECHNICAL FIELD

The present invention relates to a data mediation system and method, more particularly to a system for mediating data collected based on Internet of Things technology between a data consumer and a data supplier and a method thereof.

### BACKGROUND ART

The expression Internet of Things (IoT) first appeared in the Auto-ID Lab at the Massachusetts Institute of Technology (MIT) in 1998. In 2005, ITU-T predicted that IoT would become the most basic framework covering all forms due to future information technology (IT) revolution while presenting their annual report “The Internet of Things”. This report defined IoT as “a new information communication infrastructure that connects all things in the world to each other through networks such that communication between people and things or things and things can be conducted anytime, anywhere.” That is, IoT can be regarded as an infrastructure in deed for realizing a ubiquitous space. Such a ubiquitous space is realized first by embedding computing devices with specific functions in environments and things, thereby intellectualizing the environments and things per se.

IoT service is a technology providing more convenience and safety to people. Accordingly, many telecommunication companies and terminal manufacturers are concentrating on development of terminals and services for supporting IoT that will emerge as a next-generation mobile service.

Recently, services combining IoT devices and web services are expanding. Particularly, technologies, such as “sensor terminal SW platform technology,” for supporting sensor mashup through easy connection and control between smart devices and things have been proposed. Most services are provided by events, and services are provided only using basic data provided by things. Accordingly, since data used in mashup services are discarded, data utilization is low and personalized services are mainly provided.

### DISCLOSURE

### Technical Problem

Therefore, the present invention has been made in view of the above problems, and it is one object of the present invention to provide an information mediation system for processing various data and information, which are generated in a service process using IoT devices and web service mashup, in various forms so as to mediate the data and information between a supplier and a consumer, and an information mediation method by the information mediation system.

### Technical Solution

In accordance with one aspect of the present invention, provided is A data mediation system, including: a plurality of IoT devices, a consumer terminal that registers a data processing rule to generate customized data; and a data mediation server that generates the customized data by applying the data processing rule to data collected from the IoT devices.

The data mediation system may further include a supplier terminal that registers the IoT devices at the data mediation server and sets data provided from the registered IoT devices to public target items and non-public target items

The data mediation system may further include an IoT device gateway that connects some of the IoT devices to the data mediation server, wherein the IoT device gateway processes data collected from the connected IoT devices and provides the processed data to the data mediation server.

The data mediation server may calculate a data sale price for a data supplier providing data collected in the IoT devices and may calculate a data purchase price for a data consumer receiving the customized data.

When the customized data is provided to a data consumer who is not a data consumer registering the data processing rule, the data mediation server may calculate a data sale price for the data consumer registering the data processing rule.

The data mediation server may calculate the data purchase price highly as a data processing frequency to generate customized data is high.

The data mediation server may calculate the data purchase price highly as a search condition to search customized data becomes narrow in scope.

At least one of the IoT devices may be a service app installed in a portable terminal, wherein the service app may collect data provided from a user app installed in the portable terminal and may provide the collected data to the data mediation server.

The data mediation server may receive data, which is collected in the IoT devices, from a web server that stores data collected from at least of the IoT devices and may provide cloud-based file storage/sharing services, at a preset cycle or as needed and classifies the received data by type, followed by generating processed data or customized data according to a data processing rule.

In accordance with another aspect of the present invention, provided is a data mediation system, including: a data collection and storage unit that stores data collected from a plurality of IoT devices; a data processing rule management unit that manages a data processing rule; a data processing unit that processes the data collected from the IoT devices according to a data processing rule to generate customized data; and a calculation unit that calculates data transaction prices for a data supplier providing the collected data and a data consumer receiving the customized data.

A data processing rule defining a rule for generating the customized data may be registered in the data processing rule management unit by the data consumer.

The data mediation system may further include a device information management unit that manages information on the IoT devices registered by the data supplier.

The data mediation system may further include a customized data DB that stores the customized data.

In accordance with yet another aspect of the present invention, provided is a method of mediating data, the method including: a step of receiving data collected from a plurality of IoT devices; a step of processing data collected from the IoT devices according to a data processing rule to generate customized data; and a step of calculating data transaction prices for a data supplier providing the collected data and a data consumer receiving the customized data.

The method may further include a step in which the data consumer registers a data processing rule defining a rule for generating the customized data.

### Advantageous Effects

In accordance with the present invention, various data and information, which are generated in a service process using IoT devices and web service mashup, may be processed in various forms, thereby being mediated between a supplier and a consumer.

### DESCRIPTION OF DRAWINGS

FIG. 1 is a block diagram illustrating a data mediation system according to an embodiment of the present invention;

FIG. 2 is a block diagram illustrating the configuration of a data mediation server according to an embodiment of the present invention;

FIG. 3 is a drawing illustrating data processed in a data mediation server according to an embodiment of the present invention;

FIG. 4 is a drawing illustrating data processing by data combination according to the present invention;

FIG. 5 is a flowchart illustrating a data mediation method according to an embodiment of the present invention;

FIG. 6 is a drawing illustrating data processed in a data mediation server according to another embodiment of the present invention; and

FIG. 7 is a drawing illustrating an embodiment of a service app, which is installed in a portable terminal, operating in an IoT device according to an embodiment of the present invention.

### BEST MODE

Exemplary embodiments of the present invention are described in detail so as for those of ordinary skill in the art to easily implement with reference to the accompanying drawings.

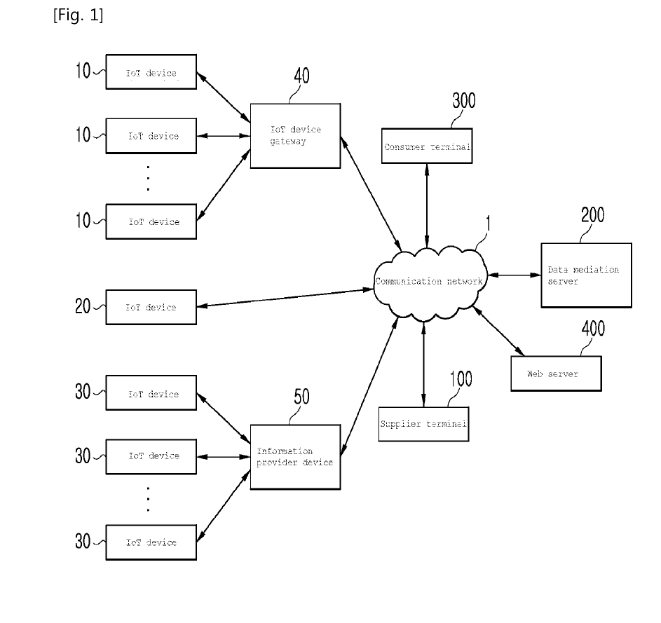

FIG. 1 is a block diagram illustrating a data mediation system according to an embodiment of the present invention.

Referring to FIG. 1, the data mediation system according to the present invention may include a plurality of IoT devices 10,20, and 30, an IoT device gateway 40, information provider equipment 50, a supplier terminal 100, a data mediation server 200, a consumer terminal 300, and a web server 400.

The data mediation server 200 may process data collected from the IoT devices 10, 20, and 30 directly or indirectly connected through a communication network 1 and may provide the processed data to a data consumer. In particular, a data processing rule from a data consumer is registered in the data mediation server 200 according to the present invention and data collected from the IoT devices 10, 20, and 30 is processed according to the registered data processing rule, thereby generating and providing customized data.

The communication network 1 may include a local area network (LAN), a metropolitan area network (MAN), a wide area network (WAN), the internet, 2G, 3G, 4G, and LTE mobile communication networks, Bluetooth, Wi-Fi, WiBro, a satellite communication network, and the like. A communication manner of the communication network 1 may be a wired or wireless method without specific limitation. That is, the communication network 1 may include any wired/wireless networks that may connect people, things, and services to one another.

Examples of the IoT devices 10, 20, and 30 include all things such as various sensors, information provision devices, convenience facilities, game consoles, security devices, and household appliances without being specifically limited. For example, examples of the IoT devices 10, 20, and 30 may include any communicable home appliances such as a communicable refrigerator, oven, washing machine, vacuum cleaner, printer, fax machine, multifunctional apparatus, webcam, television, video, DVD player, AV receiver, record player, intercom, air conditioner, heater, and dehumidifier. In addition, the IoT devices 10, 20, and 30 may include various sensors, such as a temperature sensor, a humidity sensor, a heat sensor, a gas sensor, an illuminance sensor, an ultrasonic sensor, a remote sensor, a Synthetic Aperture Radar (SAR), radar, a position sensor, a motion sensor, and an image sensor, which may obtain information from physical objects and a surrounding environment. In addition, the IoT devices 10, 20, and 30 may be implemented by a service app installed in a portable terminal such as a smartphone.

The IoT devices 10, 20, and 30 may collect various data during operation thereof and may provide the collected data to the data mediation server 200. For example, the IoT devices 10, 20, and 30, which are mounted in a vehicle, may collect information on vehicle speed, outside temperature of the vehicle, weather (rain, snow, etc.), and road surface conditions and may provide the collected information along with a GPS position and time information thereof to the data mediation server 200. Data collected in the IoT devices 10, 20, and 30 may include data generated by the IoT devices 10, 20, and 30 during operation thereof as well as data obtained from surrounding environments of the IoT devices 10, 20, and 30.

The IoT devices 10, 20, and 30 may be greatly divided into IoT devices 10, which are connected to the data mediation server 200 through the communication network 1 via the IoT device gateway 40, IoT devices 20, which are connected to the data mediation server 200 through the communication network 1 without passing through the IoT device gateway 40, and IoT devices 30, which are connected to the information provider equipment 50. Of course, other than the above forms, data collected in the IoT devices 10, 20, and 30, which are connected to the data mediation server 200 in various forms, may be provided through various routes.

The IoT device gateway 40 connects the IoT devices 10 and the communication network 1 and provides various information and data collected from the IoT devices 10 to the outside. The IoT device gateway 40 functions as a gateway such that an external device connects to the IoT devices 10, and may include a security function to protect data collected in the IoT devices 10 from forgery, extortion, and the like. The IoT device gateway 40 may process data collected from the plurality of IoT devices 10 that are connected to the IoT device gateway 40 and may transmit the processed data to the data mediation server 200. For example, when the IoT device gateway 40 is installed in a vehicle, the IoT device gateway 40 may obtain data from IoT devices 10, such as a navigation device, a black box, and an ECU, mounted in a vehicle, may process the obtained data into data that includes items, such as speed, GPS information, impact detection, and wiper operation, and may transmit the processed data.

The information provider equipment 50 is a device managed and operated by a public agency or a private business operator who operates the business to provide data collected from the IoT devices 30 to the data mediation server 200.

The supplier terminal 100 is an information communication terminal, which is used by a data supplier, providing data collected in the IoT devices 10, 20, and 30 to the data mediation server 200 and receiving a price for the data provision. Here, examples of the data supplier include individuals and organizations, such as public institutions, corporations, and nonprofits, who provide data collected from the IoT devices 10, 20, and 30 installed in a home, a vehicle, and the like or the IoT devices 10, 20, and 30, such as a smartphone and a wearable device, carried by a user, and receives a price for the data provision.

The consumer terminal 300 is an information communication terminal that is used by a data consumer who registers data processing rules of data collected from the IoT devices 10, 20, and 30 in the data mediation server 200 and receives data processed according to the data processing rules registered by the data consumer.

The supplier terminal 100 and the consumer terminal 300 may be terminals, such as a desktop computer, a notebook computer, a workstation, a palmtop computer, an ultra mobile personal computer (UMPC), a tablet PC, a personal digital assistant (PDA), and a webpad, which are equipped with memories and microprocessors and thus have computation capability.

The web server 400, which is a device for providing various services which an external device connected through the communication network 1 requests, may provide various information and data according to request of the data mediation server 200. For example, when the web server 400 provides cloud-based file storage/sharing services, data collected from the IoT devices 10, 20, and 30 may be stored in a data storage (not shown) that is managed by the web server 400. A data supplier requests the web server 400 to receive data collected in the IoT devices 10, 20, and 30, and provides information on the received data to the data mediation server 200. Accordingly, the data mediation server 200 receives data, which has been collected from the IoT devices 10, 20, and 30, from the web server 400 at a preset cycle or as needed and sorts the received data by type, followed by generating processed data or customized data according to a data processing rule. That is, original data collected in the IoT devices 10, 20, and 30 is stored in the data storage managed by the web server 400, and the data mediation server 200 processes the original data to generate data sorted by type, processed data, or customized data and stores only the generated data. Accordingly, data storage burden may be reduced. In view of a data supplier, personal information and the like may be more stably managed in that original data collected from the IoT devices 10, 20, and 30 are managed in an area which is capable of being managed by the data supplier and data obtained by processing the original data is only stored in the data mediation server 200. Meanwhile, the web server 400 may be used to provide data generated or collected in a process, in which a web service is provided, like data collected from the IoT devices 10, 20, and 30, to the data mediation server 200 to generate customized data. For example, when the web server 400 provides an IPTV service, various data, e.g., various information such as viewership by channel, viewer's age and gender, and viewing time, generated during the IPTV service may be provided, as data collected from the IoT devices 10, 20, and 30, to the data mediation server 200.

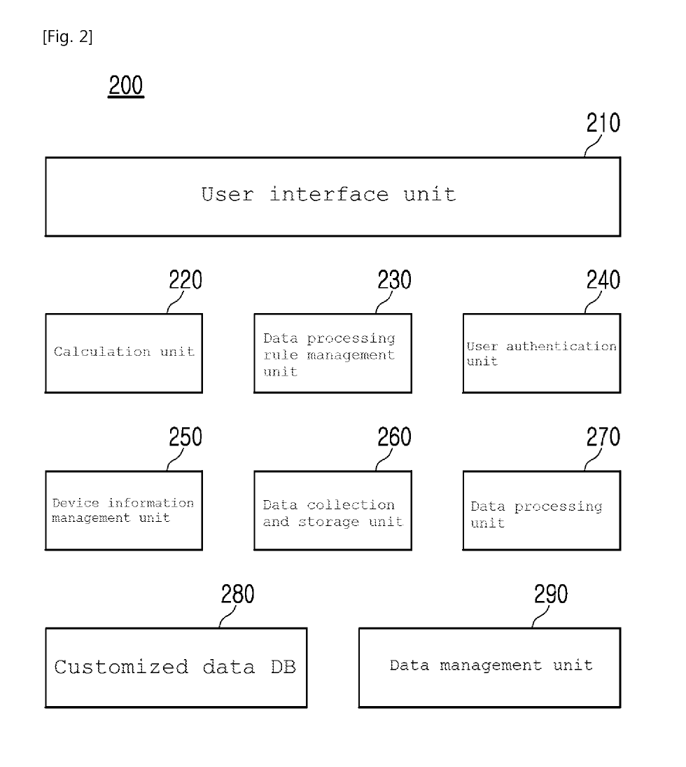

FIG. 2 is a block diagram illustrating the configuration of a data mediation server according to an embodiment of the present invention.

Referring to FIG. 2, the data mediation server 200 may include a user interface unit 210, a calculation unit 220, a data processing rule management unit 230, a user authentication unit 240, a device information management unit 250, a data collection and storage unit 260, a data processing unit 270, a customized data DB 280, and a data management unit 290.

The user interface unit 210 provides a user interface for receiving various information input and settings with respect to data mediation services according to the present invention, such as a member information input page, an IoT device registration page, an IoT device management page, a customized data order page, and a data processing rule registration page, from a data supplier or a data consumer.

The calculation unit 220 settles a price for provision of data, which is collected from the IoT devices 10, 20, and 30, to the data mediation server 200 and a data sale price to a data supplier, or a price for customized data, which is received from the data mediation server 200, and a data purchase price to a data consumer.

The data processing rule management unit 230 stores a data processing rule table, and provides necessary information according to a request. Here, the data processing rule table may include information on a data processing rule, data prices, data reliability, and the like.

The data processing rule refers to a rule for processing data collected from the IoT devices 10, 20, and 30 to generate processed data or customized data. Here, the processed data refers to data which is collected from the IoT devices 10, 20, and 30 and then is processed according to a data processing rule, before generation of customized data. In addition, the customized data refers to data that is defined by a data consumer and finally generated according to a data processing rule. The data processing rule is described in detail below.

The user authentication unit 240 may execute a user authentication function to a data supplier or a data consumer who connects to the data mediation server 200 via the supplier terminal 100 or the consumer terminal 300. To accomplish this, the user authentication unit 240 may receive registered identification information and personal information on the data supplier or the data consumer and may manage the same. In the case of a data supplier, the data supplier may register IoT devices 10, 20, and 30 that are managed by the data supplier himself, after user authentication. A data consumer may purchase necessary data from the data mediation server 200.

The device information management unit 250 manages device information of the IoT devices 10, 20, and 30, registration of which has been requested by a data supplier. Identification information of the IoT devices 10, 20, and 30 (for example, specific device MAC address, serial information, and the like), provided data items, and the like may be registered in the device information management unit 250 and may be managed by the device information management unit 250. When device information of the IoT devices 10, 20, and 30 is registered in the device information management unit 250, public target items among data items that are provided by the IoT devices 10, 20, and 30 may be set by a data supplier. For example, assuming that data provided by the IoT devices 10, 20, and includes items such as time, GPS positions, speed information, and engine temperature, a data supplier may set to publish all data items or selectively publish some items.

The device information management unit 250 may map identification information of the IoT devices 10, 20, and on identification information of a data supplier and may manage the same. Of course, the data mediation server 200 may include a database (not shown) for separately storing identification information of the IoT devices 10, 20, and 30 and identification information of a data supplier.

Data collected from the IoT devices 10, 20, and 30 is transmitted to the data collection and storage unit 260 via the communication network 1. The transmitted data is classified by type and then stored in the data collection and storage unit 260. The data collection and storage unit 260 may apply an expiration date, which has been set by a data supplier or a manager of the data mediation server 200, to data classified by type and may store the same.

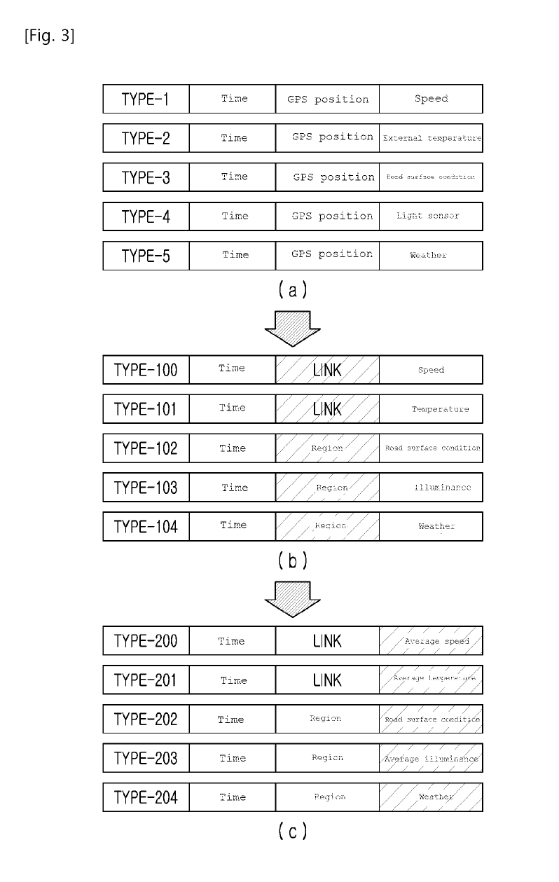

FIG. 3(a) is a drawing of illustrating an embodiment of data which is collected in the IoT devices 10, 20, and 30 and then classified by type according to an embodiment of the present invention.

Referring to FIG. 3(a), the data collection and storage unit 260 may classify data collected in the IoT devices 10, 20, and 30 by predetermined type. For example, data constituted of a time item, a GPS position item, and a speed item may be classified as“TYPE-Γ,” data constituted of a time item, a GPS position item, and an external temperature item may be classified as“TYPE-2,” data constituted of a time item, a GPS position item, and a road surface condition item may be classified as“TYPE-3,” data constituted of a time item, a GPS position item, and an illuminance item may be classified as “TYPE-4,” and data constituted of a time item, a GPS position item, and a weather item (rain, snow, etc.) may be classified as“TYPE-5.” Other than these examples, data may be classified in various predetermined data types. For example, in the case of data constituted of four items, i.e., a time item, a GPS position item, an external temperature item, and a speed item, the data may be separated and classified into two data types, i.e., “TYPE-1” and “TYPE-2”. Here, the expression “data collected in IoT devices is classified” may include “some items of several items included in a piece of collected data are selectively combined and classified into a predetermined data type” as well as “collected data is simply classified by type”.

Meanwhile, the data collection and storage unit 260 may classify data collected from the IoT devices 10, 20, and by type while excluding items designated as private items by a data supplier from the data to be classified. Here, the private items may be deleted from the data to be classified.

The data collection and storage unit 260 may interwork data collected from the IoT devices 10, 20, and 30 with personal information of a supplier of the data. For example, the data collection and storage unit 260 may verify data supplier identification information corresponding to identification information of the IoT devices 10, 20, and 30, and may interwork data collected in and transmitted from the IoT devices 10, 20, and 30 with personal information of a data supplier.

In accordance with an embodiment, data collected from the IoT devices 10, 20, and 30 may include personal information, such as the ID, age, residence, and gender of a user, and the data including the personal information may be provided to the data mediation server 200. To accomplish this, data collected from the IoT devices 10, 20, and 30 or the IoT device gateway 40 may include personal information of a data supplier, and the data including the personal information may be transmitted. The data including the personal information may be removed in a process of classifying by type or a process of generating processed data or customized data, whereby personal information may be safely protected. Data collected in IoT devices may include personal information only when preapproved by a data supplier. Meanwhile, data collected in IoT devices including personal information may be handled as data having high reliability, whereby a data supplier may charge higher cost.

The data processing unit 270 may process data, which has been classified by type, according to a data processing rule to generate processed data or customized data. The data processing rule may be defined by a manager of the data mediation server 200 or a data consumer.

FIG. 3(b) is a drawing illustrating data processed according to an embodiment of the present invention.

The data processing unit 270 may execute data processing to represent values of specific items of data that is collected and classified by the data collection and storage unit 260. GPS position item values of data classified into “TYPE-1” to “TYPE-5” in FIG. 3(a) may be changed into a “Link” or “Region” value as exemplified in FIG. 3(b). For example, as exemplified in “TYPE-100” and “TYPE-101,” GPS positions (GPS coordinates (latitude, longitude)) measured in a GPS module may be converted into “Link”, which corresponds to a road section used in a data format specification, such as Transport Protocol Experts Group (TPEG), rather than being used as it is. Of course, as exemplified in “TYPE-102” to “TYPE-104,” GPS positions may be converted into region units such as a town, a township, a block, and a building. A new type of data may be generated by data processing.

Meanwhile, the data processing may include, other that conversion of items in a piece of data as exemplified in FIG. 3(b), simultaneous conversion of several items in a plurality of data to generate new-type data. In addition, another data processing rule may be applied to data that has already been processed once, thereby generating a new type of processed data.

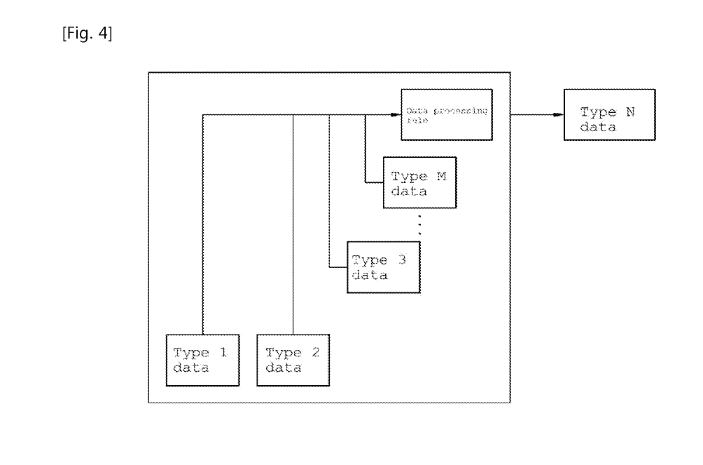

FIG. 4 is a drawing illustrating data processing by data combination according to the present invention.

Referring to FIG. 4, the data processing unit 270 may combine various data types, such as Type 1 data to Type M data, and may generate Type N data according to a data processing rule. The generated Type N data may be utilized as source data in a subsequent data processing step.

Referring to FIG. 3 again, the data processing unit 270 may execute one or more data processing processes for data collected from the IoT devices 10, 20, and 30, thereby finally generating customized data as exemplified in FIG. 3(c).

For example, when a data consumer orders an average speed of a vehicle at a specific link in a specific time zone as customized data and registers a consequent data processing rule, TYPE-200 data may be provided. The data processing unit 270 may generate TYPE-200 data by combining a plurality of TYPE-100 data at the same link in the same time zone. Here, TYPE-200 data may be a result that is generated by combining a plurality of TYPE-100 data provided by several data suppliers and processing the combined TYPE-100 data according to a data processing rule. In the case of TYPE-202 data or TYPE-204 data, a value corresponding to a road surface condition or weather condition having a highest frequency, as a result of combining TYPE-102 data or TYPE-104 data, may be determined as a road surface condition value or a weather value. For example, when a road surface condition is determined as “slippery” as a result of combining data corresponding to TYPE-102, a road surface condition of TYPE-204 data may be determined as “slippery.”

Meanwhile, the reliability of TYPE-200 data may be calculated according to the number of TYPE-100 data used to generate TYPE-200 data. For example, a data reliability of 90% may be obtained when less than 10 pieces of data are used or a data reliability of 95% may be obtained when 10 to 100 pieces of data are used. That is, a data reliability may be determined according to a predetermined standard. Prices may be differently set depending upon data reliability.

The customized data DB 280 stores consumer customized data generated by the data processing unit 270. The customized data is stored in the customized data DB 280 to correspond to information on a consumer who requests the data. The stored customized data may be provided according to a request of an authorized data consumer. The customized data may be provided to the consumer terminal 300, an external device (not shown) preset by the consumer, or the like.

The data management unit 290 may deliver data, which has been collected and classified by the data collection and storage unit 260, to the data processing unit 270 to be processed according to a data processing rule. The data management unit 290 may provide a history of data, which has been provided from a data supplier, used in the data collection and storage unit 260 or the data processing unit 270 to the calculation unit 220 such that the history is used as a basis of charges levied on a data consumer or payment to a data supplier.

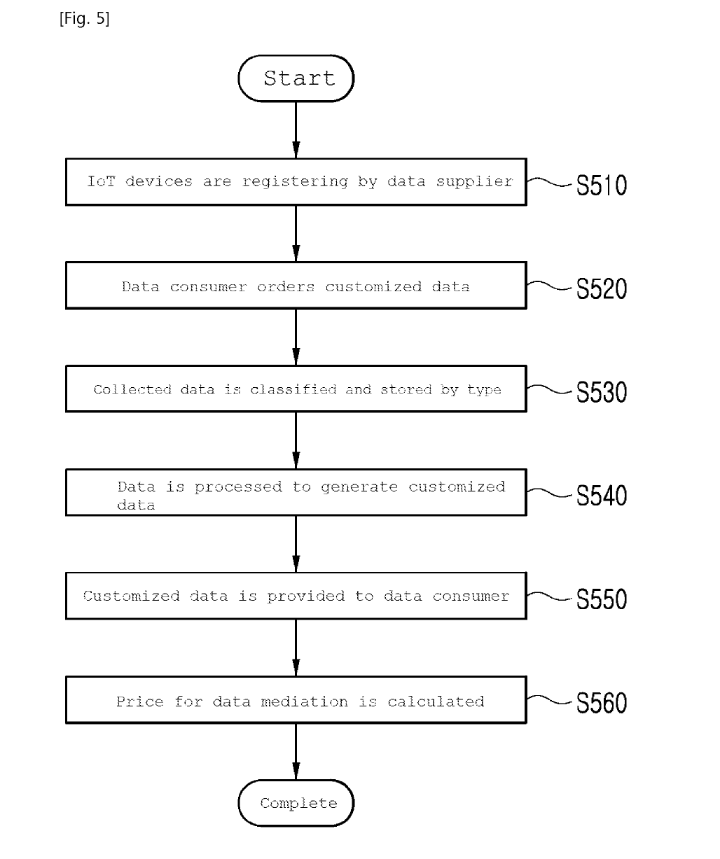

Hereinafter, a data mediation method according to the present invention is described in detail with reference to FIG. 5.

FIG. 5 is a flowchart illustrating a data mediation method according to an embodiment of the present invention.

Referring to FIG. 5, first, a data supplier may register device information on IoT devices 10, 20, and 30 there of (S510). In S510, the data supplier may connect to the data mediation server 200 via the supplier terminal 100 to execute user authentication, and then may register device information on IoT devices 10, 20, and 30 there of in a device information management page provided by the data mediation server 200. For example, when the data supplier selects IoT device registration on a device information management page displayed on the supplier terminal 100, the data mediation server 200 may deliver a device authentication token to the supplier terminal 100. Next, the supplier terminal 100 may deliver the device authentication token to the IoT devices 10, 20, and 30. The IoT devices 10, 20, and 30, to which the device authentication token has been delivered, may deliver their own identification information (e.g., specific MAC addresses and serial information of devices and the like), along with the device authentication token, to the data mediation server 200 to register device information thereof. For user convenience, merely by accessing the supplier terminal 100 to the IoT devices 10, 20, and 30 when the IoT devices 10, 20, and 30 include an NFC module and the like, an authentication token may be delivered to the IoT devices 10, 20, and 30 and the IoT devices 10, 20, and 30 may be registered. Other than this manner, a manner wherein the IoT device gateway 40 is registered in the data mediation server 200, data collected in the IoT devices 10 is combined by the IoT device gateway 40, and the combined data is transmitted to the data mediation server 200 may be used. Of course, a manner wherein the information provider equipment 50, instead of the IoT device gateway 40, is registered in the data mediation server 200, the information provider equipment 50 combines data collected in the IoT devices 30, and the combined data is transmitted to the data mediation server 200 may be used.

In S510, when a data supplier registers device information of the IoT devices 10, 20, and 30, the data supplier may select public target items from data items collected in the IoT devices 10, 20, and 30. As described above, assuming that items, such as a GPS position, speed information, and engine temperature, are included in data provided from the IoT devices 10, 20, and 30, the data supplier may set to publish all data items or selectively publish some items. As in the IoT device registration step (S610), data items to be published may be subsequently changed and set by a data supplier who connects to a device management page provided by the data mediation server 200.

After IoT device registration is completed in S510, data collected in the IoT devices 10 and 30 may be provided to the data mediation server 200 through the communication network 1 via the IoT device gateway 40 or the information provider equipment 50. In an embodiment, the IoT devices 20, which is capable of being directly connected to the communication network 1, may directly provide collected data to the data mediation server 200 without passing through the IoT device gateway 40 or the information provider equipment 50.

Next, a data consumer may order customized data, which the data consumer desires to receive, from the data mediation server 200 (S520). In S520, the data consumer may connect to the data mediation server 200 via the consumer terminal 300, may first check useable data types, and, only when a data type, which the data consumer desires to order, is included in the useable data types, may order desired data as customized data. On the other hand, when finally customized data is not a useable data type, a data processing rule may be registered to generate the customized data based on a useable data type.

In S520, a data consumer may search for desired data through category search or keyword search. For example, data collection sites, such as a vehicle, a home, a greenhouse, a factory, and an office, may be classified into categories, and collected data items in the categories may be presented to be selected by a user. Alternatively, data items, such as temperature, humidity, and illuminance, may be classified, and data collection site items are presented in the categories to be selected by a user. Other than these methods, data categories may be presented in various methods such that a data consumer may search for desired data. Meanwhile, keywords, such as a vehicle, a home, a greenhouse, speed, temperature, and illuminance, may be input, and data items corresponding to the input keywords may be presented as a search result.

Meanwhile, in S520, a data consumer may select a category “home” and then select temperature items from several items included in the category “home,” followed by setting particular search conditions, such as a city/a county/a district, a town/a township/a block, a period, and reliability, to search for data desired by the data consumer. In addition, the data consumer may search for desired data by searching using a natural language such as “average temperature for December in Yeongdeungpo-gu, Seoul.” Other than this method, a data consumer may search for desired data from the data mediation server 200 in other various methods.

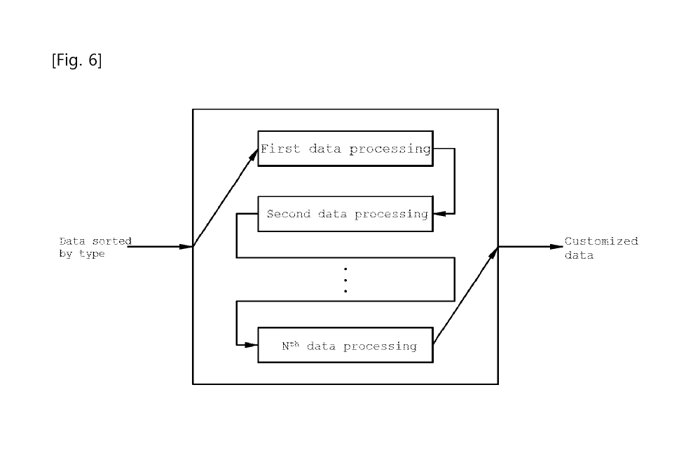

When customized data is ordered in S520, a data purchase price depending upon data reliability and the like may be checked. In addition, a data purchase price may be calculated based on the price of processed data used to generate customized data and may be checked by a data consumer. Meanwhile, when the data purchase price is calculated, the price of data having a high processing frequency may be calculated highly. For example, when data generated by processing data, which has been classified and stored by type, according to a first data processing rule is first processed data, data generated by processing the first processed data according to a second data processing rule is second processed data, . . . , data generated by processing N−1^{th} processed data according to an N^{th} data processing rule is N^{th} processed data, as exemplified in FIG. 6, the price of the first processed data may be calculated most lowly and the price may be calculated highly with increasing processing frequency, whereby the price of the N^{th} processed data may be calculated most highly. As a search condition to search desired customized data becomes narrow in scope, a price may be highly calculated. In addition, when customized data is stored in the form of a specific repost document, it is possible to set an additional cost to be calculated. Of course, the price may be differently calculated depending upon data reliability.

S520 may be executed at any time during the data mediation server 200 according to selection of a data consumer.

The data mediation server 200 may classify and store, by type, collected data in the IoT devices 10, 20, and 30 and the like as exemplified in FIG. 3(a) (S530). In S530, the data mediation server 200 may classify, by type data, collected from the IoT devices 10, 20, and 30 while excluding items, which are designated as private items by a data supplier, from data to be classified. Here, private items may be deleted from the data to be classified. Meanwhile, the data mediation server 200 may store supplier information of data classified and stored in S530 to be used for payment for subsequent data provision. In addition, the data mediation server 200 may set an expiration date of data collected and classified in S530 such that the data is used for customized data generation only during the expiration date.

Next, the data mediation server 200 may process data, which has been classified by type, according to a data processing rule to generate processed data or customized data (S540). The data mediation server 200 may execute at least one data processing for the collected and classified data, thereby finally generating customized data as exemplified in FIG. 4(c). A data processing rule may be defined by a manager of the data mediation server 200 or a data consumer. New-type processed data, which has been generated by data processing, may be used as a source to generate another type of processed data or customized data. Of course, in accordance with an embodiment, the customized data may be used as a source to generate another customized data.

The data mediation server 200 may provide the customized data generated in S540 to the consumer terminal 300, a pre-designated external device, or the like according to a request of a data consumer (S550).

In addition, the data mediation server 200 may charge a data consumer a price for provision of the customized data every month or at regular intervals, and may pay a data supplier with a price for data provision (S560). Meanwhile, in an embodiment, when customized data, which is generated according to a data processing rule that is registered by a first data consumer, is provided to a second data consumer, the price for data provision may be set to be paid to the first data consumer. That is, activation of the data mediation service according to the present invention may be promoted by paying a certain price to a data supplier who provides data collected from the IoT devices 10, 20, and 30 as well as a data consumer who registers a data processing rule to convert the collected data into customized data.

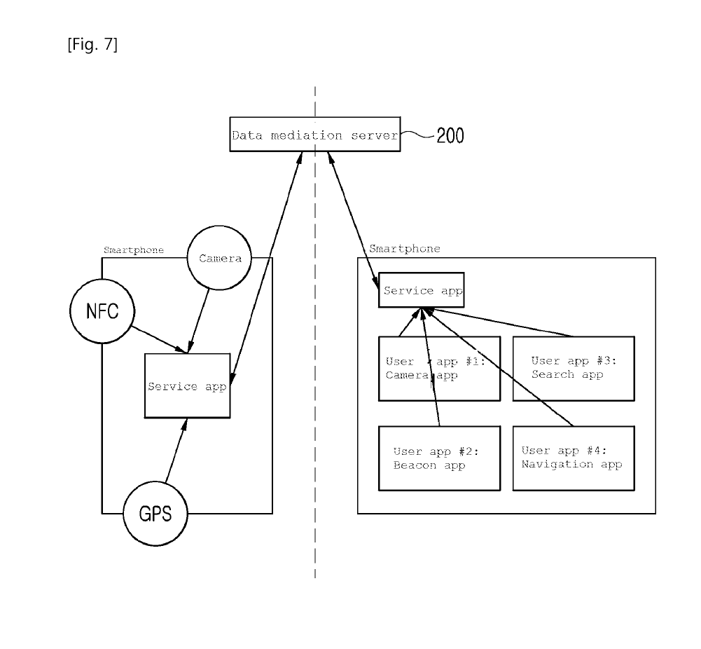

FIG. 7 is a drawing illustrating an embodiment of a service app, which is installed in a portable terminal, operating in an IoT device according to an embodiment of the present invention.

Referring FIG. 7(a), a service app according to the present invention may directly collect data from a camera, an NFC module, a GPS module, and various sensor modules installed in a portable terminal and may provide the collected data to the data mediation server 200.

Referring to FIG. 7(b), a service app according to another embodiment of the present invention may collect data provided by individual user apps, such as a camera app, a search app, a Beacon app, and a navigation device, and may provide the collected data to the data mediation server 200. To accomplish this, the individual user apps should be realized to provide data thereof to a service app. Meanwhile, when the individual user apps include an API module configured to transmit collected data to the data mediation server 200, the individual user apps may become service apps according to the present invention.

Embodiments of the present invention can include a computer readable medium including program commands for executing operations implemented through various computers. The computer readable medium records a program for implementing the aforementioned data mediation method. The computer readable medium can store program commands, data files, data structures or combinations thereof. Examples of the computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Alternatively, the computer readable recording medium may be a transmission medium, such as optical or metal lines or waveguides, including carrier waves that transmit signals designating program commands, data structures, and the like. Examples of the program commands include machine language code created by a compiler and high-level language code executable by a computer using an interpreter and the like.

While the preferred embodiments of the present invention has been described in detail, those skilled in the art will appreciate that the scope of the present invention is not limited to the preferred embodiments and many modifications and changes can be made to the present invention without departing from the spirit and essential characteristics of the present invention

1. A data mediation system, comprising:
a plurality of IoT devices,
a consumer terminal that registers a data processing rule to generate customized data; and
a data mediation server that generates the customized data by applying the data processing rule to data collected from the IoT devices.

2. The data mediation system according to claim 1, further comprising a supplier terminal that registers the IoT devices at the data mediation server and sets data provided from the registered IoT devices to public target items and non-public target items.

3. The data mediation system according to claim 1, further comprising an IoT device gateway that connects some of the IoT devices to the data mediation server, wherein the IoT device gateway processes data collected from the connected IoT devices and provides the processed data to the data mediation server.

4. The data mediation system according to claim 1, wherein the data mediation server calculates a data sale price for a data supplier providing data collected in the IoT devices and calculates a data purchase price for a data consumer receiving the customized data.

5. The data mediation system according to claim 4, wherein, when the customized data is provided to a data consumer who is not a data consumer registering the data processing rule, the data mediation server calculates a data sale price for the data consumer registering the data processing rule.

6. The data mediation system according to claim 4, wherein the data mediation server calculates the data purchase price highly as a data processing frequency to generate customized data is high.

7. The data mediation system according to claim 4, wherein the data mediation server calculates the data purchase price highly as a search condition to search customized data becomes narrow in scope.

8. The data mediation system according to claim 1, wherein at least one of the IoT devices is a service app installed in a portable terminal, wherein the service app collects data provided from a user app installed in the portable terminal and provides the collected data to the data mediation server.

9. The data mediation system according to claim 1, wherein the data mediation server receives data, which is collected in the IoT devices, from a web server that stores data collected from at least of the IoT devices and provides cloud-based file storage/sharing services, at a preset cycle or as needed, classifies the received data by type, and generates the classified data into processed data or customized data according to a data processing rule.

10. A data mediation system, comprising:
a data collection and storage unit that stores data collected from a plurality of IoT devices;
a data processing rule management unit that manages a data processing rule;
a data processing unit that processes the data collected from the IoT devices according to a data processing rule to generate customized data; and
a calculation unit that calculates data transaction prices for a data supplier providing the collected data and a data consumer receiving the customized data.

11. The data mediation system according to claim 10, wherein a data processing rule defining a rule for generating the customized data is registered in the data processing rule management unit by the data consumer.

12. The data mediation system according to claim 10, further comprising a device information management unit that manages information on the IoT devices registered by the data supplier.

13. The data mediation system according to claim 10, further comprising a customized data DB that stores the customized data.

14. A method of mediating data, the method comprising:
a step of receiving data collected from a plurality of IoT devices;
a step of processing data collected from the IoT devices according to a data processing rule to generate customized data; and
a step of calculating data transaction prices for a data supplier providing the collected data and a data consumer receiving the customized data.

15. The method according to claim 14, further comprising a step in which the data consumer registers a data processing rule defining a rule for generating the customized data.
